(19) United States
(12) Patent Application Publication
(10) Pub. No.: US 2018/0038946 A1
(43) Pub. Date: Feb. 8, 2018

(54) 3D DEPTH SENSOR AND METHOD OF MEASURING DISTANCE USING THE 3D DEPTH SENSOR

(71) Applicant: SAMSUNG ELECTRONICS CO., LTD., Suwon-si (KR)

(72) Inventors: Myungjae JEON, Yongin-si (KR); Yonghwa PARK, Yongin-si (KR); Jangwoo YOU, Seoul (KR)

(73) Assignee: SAMSUNG ELECTRONICS CO., LTD., Suwon-si (KR)

(21) Appl. No.: 15/669,154

(22) Filed: Aug. 4, 2017

(30) Foreign Application Priority Data
Aug. 5, 2016 (KR) 10-2016-0100121

(51) Int. Cl. G01S 7/486; G02B 26/04; G01S 17/89; G01S 17/32

(52) U.S. Cl. CPC G01S 7/4868; G01S 17/32; G02B 26/04; G01S 17/89; G02B 2207/101

(57) ABSTRACT

A 3D depth sensor and a method of measuring a distance to an object, using the 3D depth sensor, are provided. The 3D depth sensor includes a light source configured to emit light toward an object, and an optical shutter configured to modulate a waveform of light that is reflected from the object by changing a transmittance of the reflected light, the optical shutter comprising sections. The 3D depth sensor further includes an optical shutter driver configured to operate the sections of the optical shutter independently from one another, and a controller configured to control the light source and the optical shutter driver.

### CROSS-REFERENCE TO RELATED APPLICATION

This application claims priority from Korean Patent Application No. 10-2016-0100121, filed on Aug. 5, 2016, in the Korean Intellectual Property Office, the disclosure of which is incorporated herein by reference in its entirety.

### BACKGROUND

### 1. Field

Apparatuses and methods consistent with exemplary embodiments relate to 3-dimensional (3D) depth sensors and methods of measuring a distance by using the 3D sensors.

### 2. Description of the Related Art

With the development of 3D display devices that may express an image of depth and the increase in demand for the 3D display devices, studies have been conducted about various 3D image capturing devices by which a user may manufacture a 3D content. Also, studies about 3D cameras, motion capture sensors, and laser radar LADARs that can obtain distance information to an object have been increased.

A 3D depth sensor that includes an optical shutter or a depth camera uses a Time of Flight (TOF) method. In the TOF method, an optical flying time is measured until light reflected at the object is received by a sensor after irradiating the light to the object. In this method, the 3D depth sensor may measure a distance to the object by measuring the time for returning light emitted from a light source and reflected at the object.

The 3D depth sensor is applied to various fields, that is, may be used as general a motion capture sensor and a camera for detecting depth information in various industrial fields.

### SUMMARY

Exemplary embodiments may address at least the above problems and/or disadvantages and other disadvantages not described above. Also, the exemplary embodiments are not required to overcome the disadvantages described above, and may not overcome any of the problems described above.

Exemplary embodiments provide 3D depth sensors in which an optical sensor of which is divided into several sections, and drivers corresponding to each of the sections are independently connected to each other, and methods of measuring a distance by using the 3D depth sensor.

According to an aspect of an exemplary embodiment, there is provided a three-dimensional (3D) depth sensor including a three-dimensional (3D) depth sensor including a light source configured to emit light toward an object, and an optical shutter configured to modulate a waveform of light that is reflected from the object by changing a transmittance of the reflected light, the optical shutter including sections. The 3D depth sensor further includes an optical shutter driver configured to operate the sections of the optical shutter independently from one another, and a controller configured to control the light source and the optical shutter driver.

The optical shutter driver may further include optical shutter drivers individually connected to electrodes respectively included in the sections of the optical shutter.

The 3D depth sensor may further include a switch configured to select an electrode from the electrodes, and the optical shutter driver may be further configured to operate the electrodes via the switch.

The optical shutter driver may include a multi-frequency optical shutter driver configured to select, from frequencies, a frequency for operating the optical shutter.

The sections of the optical shutter may be configured to respectively modulate the reflected light reflected, based on locations of the object from the 3D depth sensor.

The optical shutter may include a first electrode, a second electrode, and a multi-quantum well (MQW) structure disposed between the first electrode and the second electrode.

The 3D depth sensor may further include a first conductive type semiconductor layer disposed between the first electrode and the MQW structure, and having an n-type distributed bragg rectifier (DBR) structure.

The 3D depth sensor may further include a second conductive type semiconductor layer disposed between the second electrode and the MQW structure, and having a p-type DBR structure.

According to an aspect of another exemplary embodiment, there is provided a method of measuring a distance to an object, using a 3D depth sensor including a light source emitting light towards an object, an optical shutter modulating a waveform of light that is reflected from the object by changing a transmittance of the reflected light, the optical shutter including sections, and an optical shutter driver operating the sections of the optical shutter independently from one another. The method includes emitting light from the light source toward different locations of the object with respect to the 3D depth sensor, and acquiring distance information of the object from the 3D depth sensor by operating the sections of the optical shutter independently from one another.

The method may further include operating the sections of the optical shutter at different times, based on a time division method.

The method may further include operating an electrode included in a first section of the optical shutter via a first section driver included in the optical shutter driver, and after the operation of the electrode included in the first section of the optical shutter via the first section driver, operating an electrode included in a second section of the optical shutter via a second section driver included in the optical shutter driver.

The optical shutter driver may be a multi-frequency optical shutter driver operating electrodes included in the sections of the optical shutter via a switch that selects an electrode from the electrodes.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a cross-sectional view of a configuration of a 3D depth sensor and a phase of a wavelength used for driving the 3D depth sensor, according to an exemplary embodiment;

FIG. 2 is a perspective view of an optical shutter of a 3D depth sensor, according to an exemplary embodiment;

FIG. 3A is a cross-sectional view of an optical shutter of a 3D depth sensor, according to an exemplary embodiment;

FIG. 3B is a graph showing an electrical characteristic of the optical shutter of FIG. 3;

FIG. 3C is a diagram of a driving voltage applied to the optical shutter of FIG. 3 by a driver;

FIG. 3D is a graph showing transmittance variations of the optical shutter of FIG. 3, according to a wavelength of incident light to the optical shutter;

FIG. 4 is a diagram of a mobile robot including a 3D depth sensor according to an exemplary embodiment and a driving environment;

FIG. 5 is a plan view of a driving environment of the mobile robot including the 3D depth sensor according to an exemplary embodiment of FIG. 4;

FIG. 6 is a diagram showing a method of driving an optical shutter of a 3D depth sensor, according to an exemplary embodiment;

FIG. 7 is a flowchart illustrating a method of acquiring and processing an image of a 3D depth sensor according to an exemplary embodiment;

FIG. 8 is a diagram of a structure of an optical shutter including a switch that optionally connects each of the sections of the optical shutter and a multi-frequency shutter driver of a 3D depth sensor, according to an exemplary embodiment;

FIG. 9 is a diagram of a structure of an optical shutter driver in which optical shutter electrodes of a 3D depth sensor according to an exemplary embodiment are formed in a vertical direction and each electrode line and a shutter driver are vertically connected to each other; and

FIG. 10 is a diagram showing a matrix-type arrangement of driving electrodes of an optical shutter of a 3D depth sensor, according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

In addition, the terms such as “unit,” “-er (-or),” and “module” described in the specification refer to an element for performing at least one function or operation, and may be implemented in hardware, software, or the combination of hardware and software.

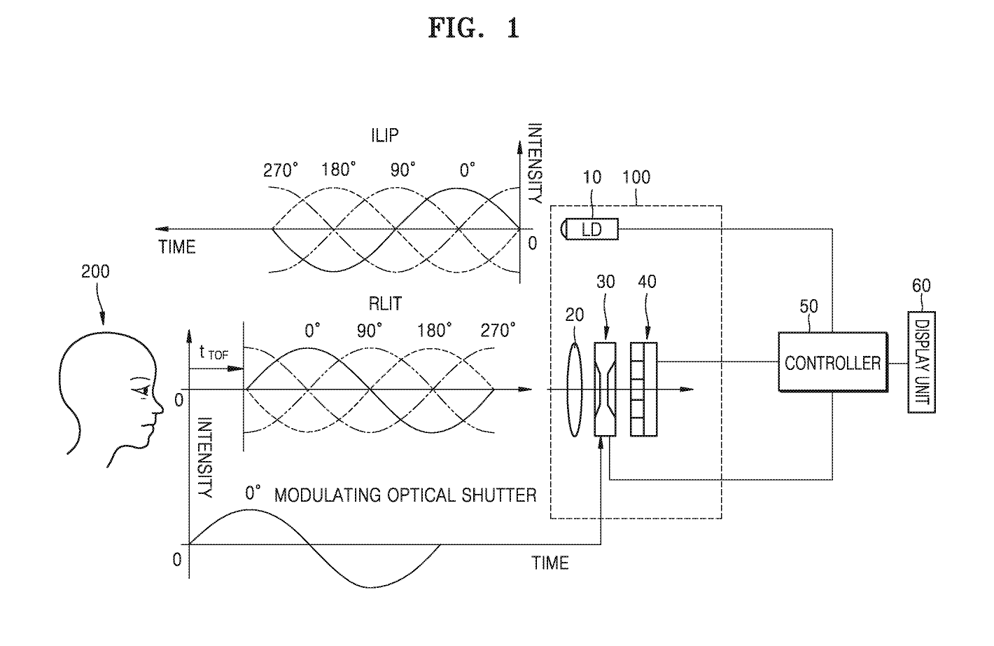

FIG. 1 is a cross-sectional view of a configuration of a 3D depth sensor 100 and a phase of a wavelength used for driving the 3D depth sensor 100, according to an exemplary embodiment.

Referring to FIG. 1, the 3D depth sensor 100 may include a light source 10 configured to emit light towards an object 200 or a subject, a lens 20 that receives light reflected at the object 200, an optical shutter 30, and an image sensor 40. The optical shutter 30 is located on a path through which light emitted to and reflected from the object 200 proceeds, and thus, may modulate or modify a waveform of reflected light by changing a transmittance of the reflected light. Also, the 3D depth sensor 100 may include a controller 50 configured to control the light source 10, the optical shutter 30, and the image sensor 40, to calculate a phase of measured reflected light at the object 200, and to compute depth information and distance information of the object 200, and a display 60 to visually display the depth information of the object 200 to the user.

The light source 10 may be a light-emitting diode (LED) or a laser diode (LD), and may emit light in a region of infrared (IR) or near infrared (near IR) to the object 200. The intensity and wavelength of light emitted towards the object 200 from the light source 10 may be controlled by controlling the magnitude of a driving voltage applied to the light source 10. Light emitted towards the object 200 from the light source 10 may be reflected at a surface, for example, a skin or cloths of the object 200. A phase difference between light emitted from the light source 10 and light reflected at the object 200 may be generated according to a distance between the light source 10 and the object 200.

Light emitted towards and reflected from the object 200 may enter the optical shutter 30 through the lens 20. The lens 20 may focus light reflected at the object 200, and light reflected at the object 200 may be transmitted to the optical shutter 30 and the image sensor 40 through the lens 20. The image sensor 40 may be, for example, a Complementary Metal Oxide Semiconductor (CMOS) or a charge coupled device (CCD), but is not limited thereto.

The optical shutter 30 may modulate or modify a waveform of light reflected at the object 200 by changing the degree of transmittance of the reflected light from the object 200. Light emitted from the light source 10 may be modulated by applying a given frequency, and the optical shutter 30 may be operated by a frequency as the same as the given frequency. The shape of modulation of reflected light by the optical shutter 30 may vary according to the phase of light entering the optical shutter 30.

FIG. 1 shows a graph showing the intensity variation of illuminating IR profile (ILIP) emitted from the light source 10 according to time and the intensity variation of reflecting IR profile (RLIT) reflected from the object 200 according to time. Also, the variation of transmittance of the optical shutter 30 is shown.

The light source 10 may sequentially emit ILIP to the object 200. A plurality of ILIPs may be emitted towards the object 200 with an idle time with different phases from each other. If N numbers of ILIPs are emitted towards the object 200 from the light source 10 and N is 4, phases of the irradiating ILIPs respectively may be 0, 90, 180, and 270 degrees.

RLITs reflected at the object 200 may enter the image sensor 40 independently from one another through the lens 20 and the optical shutter 30. In FIG. 1, it is shown that the transmittance of the optical shutter 30 varies according to time. Also, the transmittance of the optical shutter 30 may vary according to the level of a bias voltage applied to the optical shutter 30 in a wavelength region. Accordingly, the RLITs may be modulated while transmitting the optical shutter 30. The waveforms of the modulated RLITs may depend on the phases of the RLITs and the transmittance variation according to time of the optical shutter 30. The image sensor 40 may extract a phase difference between ILIPs and RLITs by capturing modulated RLITs by the optical shutter 30.

In this manner, the variation of waveforms of the RLITs of the object 200 may depend on the phases of the RLITs and the transmittance variation according to time of the optical shutter 30. Accordingly, depth information of the object 200 may be obtained by correctly controlling the transmittance of the optical shutter 30 and correcting depth information of the object 200 acquired according to an operation characteristic of the optical shutter 30.

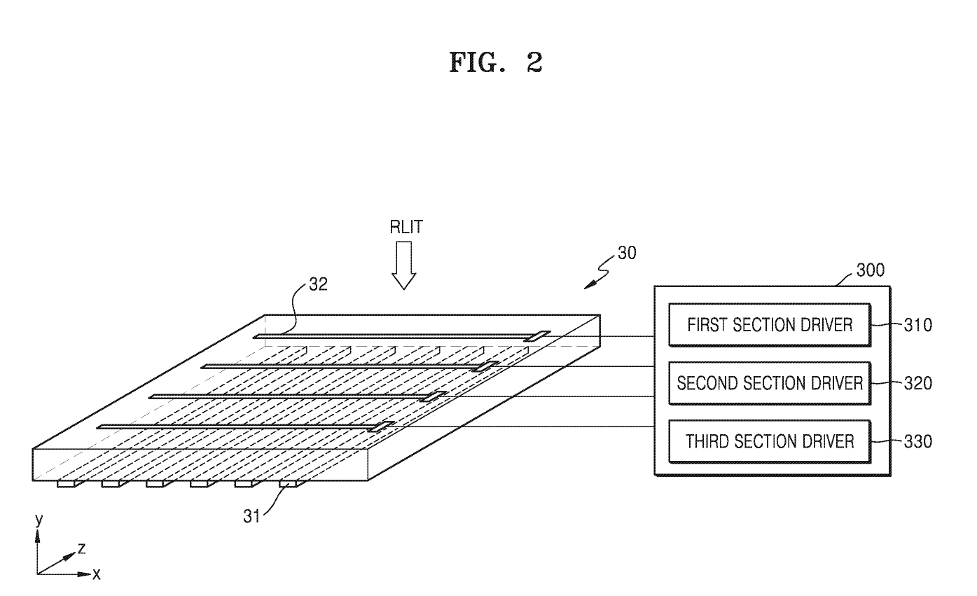

FIG. 2 is a perspective view of the optical shutter 30 of the 3D depth sensor 100, according to an exemplary embodiment.

Referring to FIG. 2, the optical shutter 30 of the 3D depth sensor 100 according to an exemplary embodiment may include a plurality of first electrodes 31 formed parallel to each other on a first surface of a semiconductor structure, and a plurality of second electrodes 32 formed parallel to each other on a second surface of the semiconductor structure. The first electrodes 31 and the second electrodes 32 may be formed in a crossing direction to each other. The first electrodes 31 may be ground electrodes, and may drive the optical shutter 30 by applying a voltage to the semiconductor structure through the second electrodes 32. The second electrodes 32 formed on each section of the optical shutter 30 may be connected to at least two optical shutter drivers 300 different from each other. In FIG. 2, the second electrodes 32 formed on at least two sections of the optical shutter 30 may be connected to a first section driver 310, a second section driver 320, and a third section driver 330 according to locations of the second electrodes 32. The first section driver 310, the second section driver 320, and the third section driver 330 are included in the optical shutter driver 300, and may drive the optical shutter 30 by being individually connected to the second electrodes 32 formed on at least two sections of the optical shutter 30.

Accordingly, the optical shutter 30 of the 3D depth sensor 100 according to an exemplary embodiment includes a plurality of the first and second electrodes 31 and 32, and may be driven by the second electrodes 32 that are connected to at least two optical shutter drivers 300 different from each other according to sections of the optical shutter 30. A first section of the optical shutter 30 may denote an upper region of a peripheral device on which the 3D depth sensor 100 is mounted and operated. The optical shutter driver 300 may be operated by the controller 50 of FIG. 1.

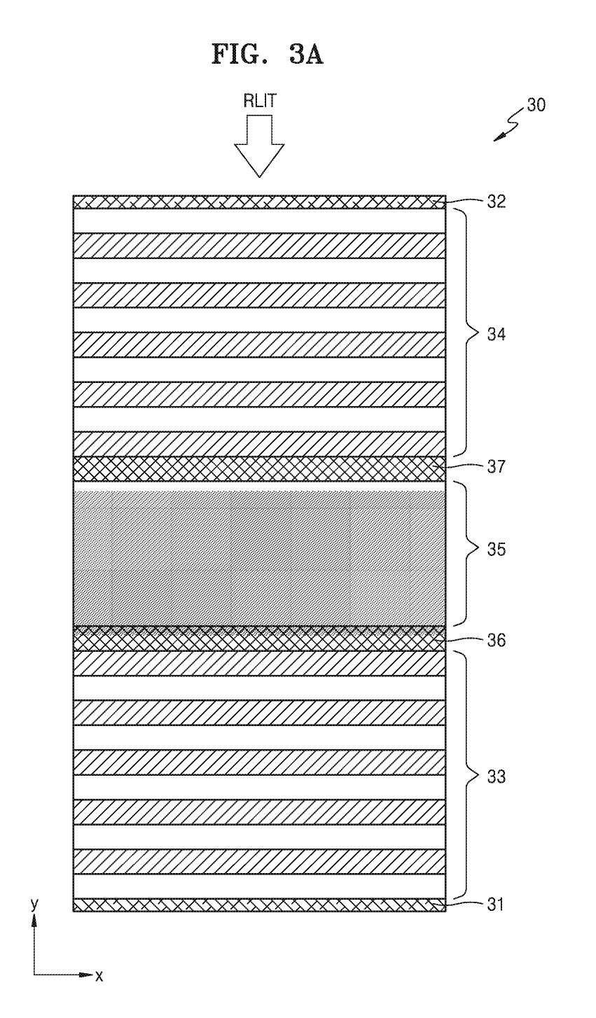

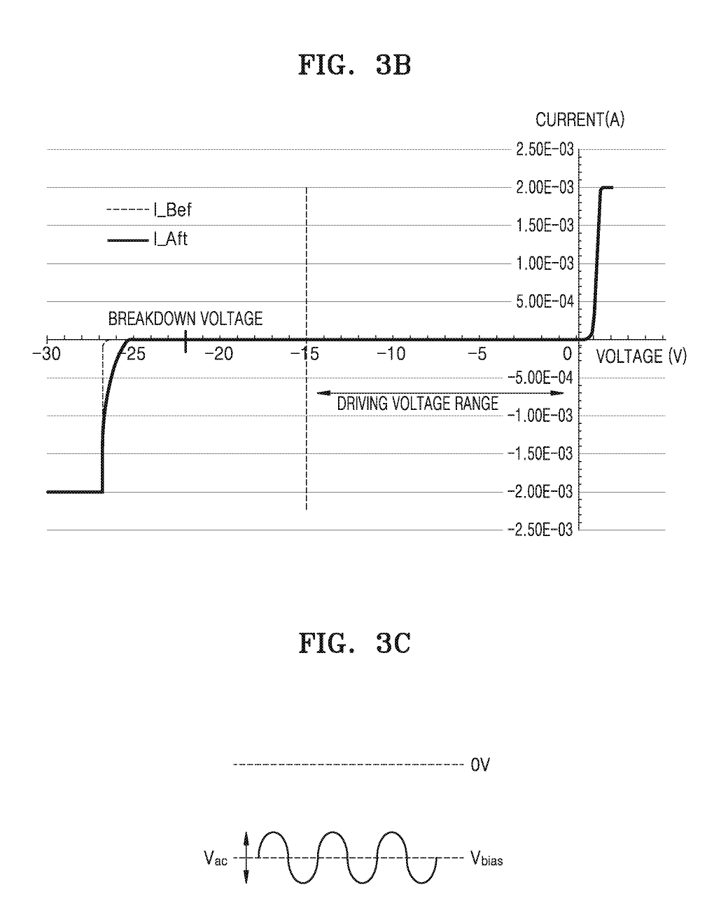

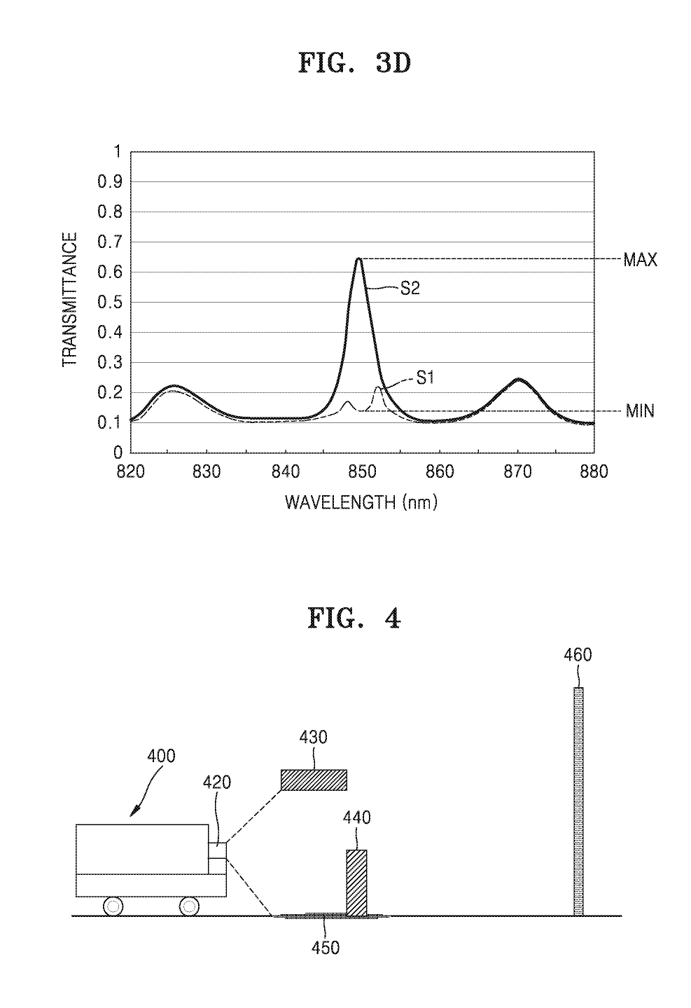

FIG. 3A is a cross-sectional view of the optical shutter 30 of the 3D depth sensor 100, according to an exemplary embodiment. FIG. 3A is a cross-sectional view of the optical shutter 30 of FIG. 2.

Referring to FIG. 3A, the optical shutter 30 may include a first electrode 31, a second electrode 32, and a multi-quantum well (MQW) structure 35 between the first and second electrodes 31 and 32. A first conductive type semiconductor layer 33 may be formed between the first electrode 31 and the MQW structure 35, and a second conductive type semiconductor layer 34 may be formed between the MQW structure 35 and the second electrode 32. Also, a first space layer 36 may be formed between the first conductive type semiconductor 33 and the MQW structure 35, and a second space layer 37 may be formed between the MQW structure 35 and the second conductive type semiconductor 34. The first electrode 31 may be an n-type electrode, and the second electrode 32 may be a p-type electrode.

The first conductive type semiconductor layer 33 may have an n-type Distributed Bragg Rectifier (DBR) structure, and the second conductive type semiconductor layer 34 may have a p-type DBR structure. For example, the first conductive type semiconductor layer 33 and the second conductive type semiconductor layer 34 may have structures in which Al0.31GaAs and Al0.84GaAs are alternately stacked. The MQW structure 35 may include GaAs/Al0.31GaAs, and the first and second space layers 36 and 37 may include Al0.31GaAs.

In this manner, the optical shutter 30 may have a structure in which the MQW structure 35 is formed between the first and second conductive type semiconductor layers 33 and 34 formed with DBR structures, and the first and second conductive type semiconductor layers 33 and 34 may perform as a resonating mirror pair and a resonance cavity. Thus, the optical shutter 30 may perform a transmitting function or a blocking function with respect to light of a frequency according to an external voltage applied to the optical shutter 30.

FIG. 3B is a graph showing an electrical characteristic of the optical shutter 30 of FIG. 3.

Referring to FIG. 3B, the optical shutter 30 may have a characteristic of a diode having a p-n junction structure, and a range of a driving voltage applied to the optical shutter 30 may be included in a reverse bias voltage range. Because the driving voltage of the optical shutter 30 is set as a reverse bias voltage range, the optical shutter 30 may absorb light. The transmittance of the optical shutter 30 may vary according to a wavelength of light reflected from the object 200 and the magnitude of a driving voltage applied to the optical shutter 30.

FIG. 3C is a diagram of a driving voltage applied to the optical shutter 30 of FIG. 3 by a driver.

Referring to FIG. 3C, the driving voltage applied to the optical shutter 30 may be controlled to be vibrated with a predetermined vibration width V_{ac} with the bias voltage V_{bias} as a center. The transmittance of the optical shutter 30 may be periodically changed when the optical shutter driver 300 changes the driving voltage of the optical shutter 30 by the controller 50 of FIGS. 1 and 2.

FIG. 3D is a graph showing transmittance variations of the optical shutter 30 of FIG. 3, according to a wavelength of incident light to the optical shutter 30.

Referring to FIG. 3D, S1 indicates a minimum transmittance of the optical shutter 30 when a driving voltage applied to the optical shutter 30 is changed. S2 indicates a maximum transmittance of the optical shutter 30 when the driving voltage applied to the optical shutter 30 is changed. A difference between the minimum transmittance and the maximum transmittance of the optical shutter 30 may vary according to wavelengths of light entering the optical shutter 30. For example, the transmittance of the optical shutter 30 for the RLIT reflected at the object 200 may vary the most according to driving voltage at a wavelength of approximately 850 nm. For effective operation of the optical shutter 30, the light source 10 may emit light having a wavelength at which the transmittance of the optical shutter 30 varies the most.

FIG. 4 is a diagram of a mobile robot 400 including the 3D depth sensor 100 according to an exemplary embodiment and a driving environment.

Referring to FIG. 4, when the mobile robot 400 on which the 3D depth sensor 100 according to an exemplary embodiment is mounted is operated, various peripheral environments around the mobile robot 400 and elements that may interrupt the movement of the mobile robot 400 are considered. For example, depth information may be acquired by receiving lights reflected at an upper object 430, a near object 440, a bottom part 450, and a remote wall 460 by irradiating light from a light source 420 of the 3D depth sensor 100 of the mobile robot 400. In order for the 3D depth sensor 100 to simultaneously process all information, all regions are in a viewing angle of a depth sensor camera.

Also, in the case of measuring distance information of all regions regardless of the distances, for example, in the case of simultaneously measuring distances to a proximity region, that is, within 30 cm from the mobile robot 400, a near region in a range from 30 cm to 1 meter, and a far region, that is, more than 3 m from the mobile robot 400, the measurement of a distance may not be easy. To measure distance information of a far region, irradiation of light of a relatively large intensity is performed. However, in the case of the ultra near region, if light of a large intensity is emitted, a light saturation phenomenon may occur, and thus, the distance measurement may be difficult.

Also, if the entire optical shutter 30 of the 3D depth sensor 100 is operated and if a modulation frequency of the optical shutter 30 is increased, problems, such as low response speed, high power consumption, and reducing a measurement distance at a far region may occur. In the 3D depth sensor 100 according to an exemplary embodiment, the optical shutter 30 may be divided into at least two sections, and each section may be connected to optical shutter drivers independently from one another.

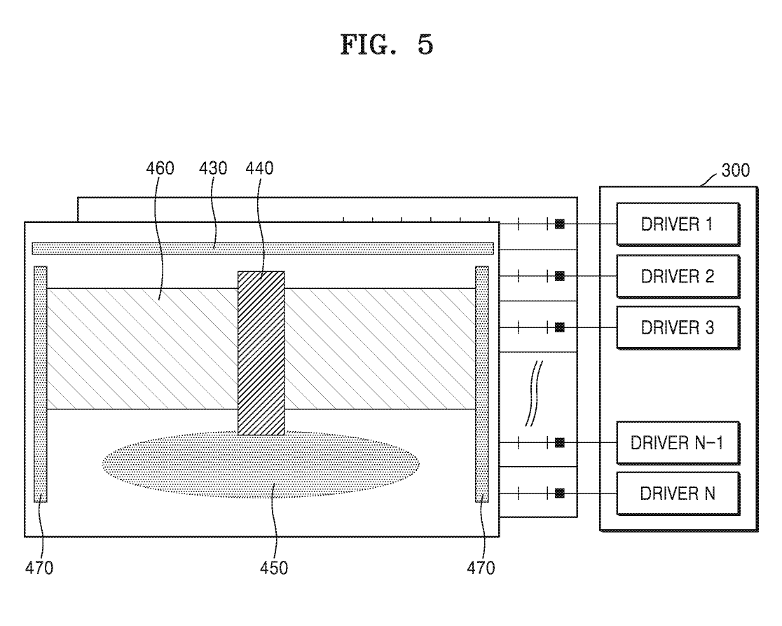

FIG. 5 is a plan view of an operating environment of the mobile robot 400 including the 3D depth sensor 100 according to an exemplary embodiment of FIG. 4.

Referring to FIGS. 4 and 5, depth information of the upper object 430, the near object 440, the bottom part 450, the remote wall 460, and side walls 470 that are peripheral environment of the mobile robot 400 may be obtained by independently operating each of the sections of the optical shutter 30 of the 3D depth sensor 100 according to an exemplary embodiment that is mounted on the mobile robot 400. In FIG. 5, as an example, a configuration in which N of the optical shutter driver 300 are incorporated for operating the optical shutter 30. For example, the optical shutter driver 300 may be divided according to the sections of the optical shutter 30 to respectively correspond to an upper region, a middle region, and a lower region of the 3D depth sensor 100. Also, the optical shutter driver 300 may include optical shutter drivers that may be operated independently from one another based on a near distance, a middle distance, and a far distance from the 3D depth sensor 100. The optical shutter driver 300 may be set according to the using environment of the 3D depth sensor 100 according to an exemplary embodiment.

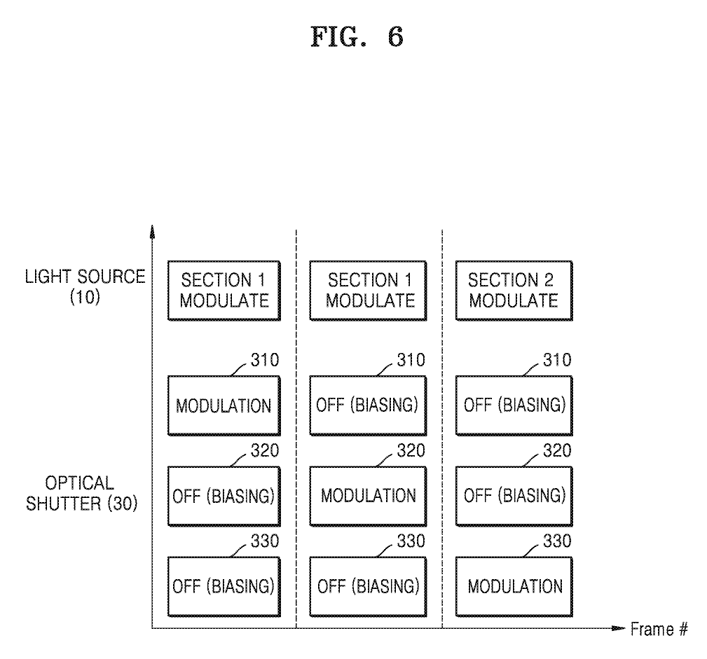

FIG. 6 is a diagram showing a method of operating the optical shutter 30 of the 3D depth sensor 100, according to an exemplary embodiment. FIG. 6 shows a method of operating the optical shutter 30 of the 3D depth sensor 100 of FIG. 2. The horizontal axis indicates an operating frame in each section, and a vertical axis indicates a sequence of operating a light source and an optical shutter.

Referring to FIGS. 1 and 6, if light is emitted towards the object 200 from the light source 10 to modulate a first section (section 1) of the optical shutter 30, light reflected at the object 200 enters the optical shutter 30. At this point, the first section driver 310 for operating the first section of the optical shutter 30 is operated (modulated), and the second section driver 320 and the third section driver 330 are maintained as an Off state (biasing state). Next, light is emitted towards the object 200 from the light source 10 to modulate a second section (section2) of the optical shutter 30, the second section driver 320 for operating the second section of the optical shutter 30 is operated (modulated), and the first section driver 310 and the third section driver 330 are maintained as an Off state. Next, light is emitted towards the object 200 from the light source 10 to modulate a third section (section3) of the optical shutter 30, the third section driver 330 for operating the third section of the optical shutter 30 is operated (modulated), and the first section driver 310 and the second section driver 320 are maintained as an Off state.

The first section (section1), the second section (section2), and the third section (section3) of the optical shutter 30 may respectively correspond to the upper region, the middle region, and the lower region of the 3D depth sensor 100, and also, may correspond to a near distance region, a middle distance region, and a far distance region from the 3D depth sensor 100. For example, the mobile robot 400 on which the 3D depth sensor 100 is mounted uses upper data to avoid collision with an upper object when the mobile robot 400 moves. In the case of an optical shutter in which the first section corresponds to the upper region of the 3D depth sensor 100, the optical shutter 30 may be operated with a high frequency by operating the first section driver 310. If an area of the optical shutter 30 is divided into small sizes, a unit cell capacitance of the optical shutter 30 may be reduced, and thus, when the optical shutter 30 is operated with a high frequency, problems, such as high power consumption problem and low response speed may be mitigated.

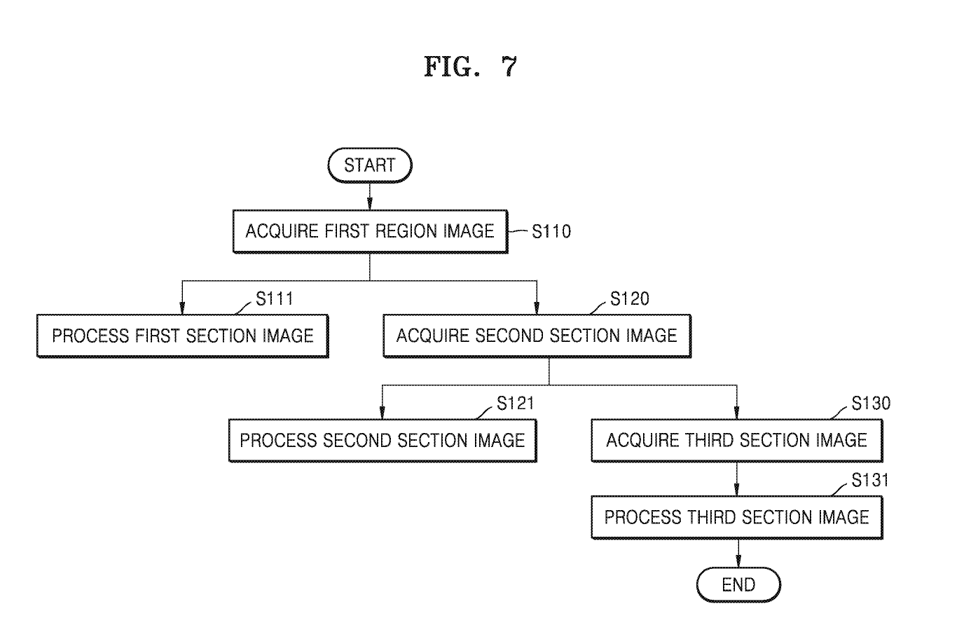

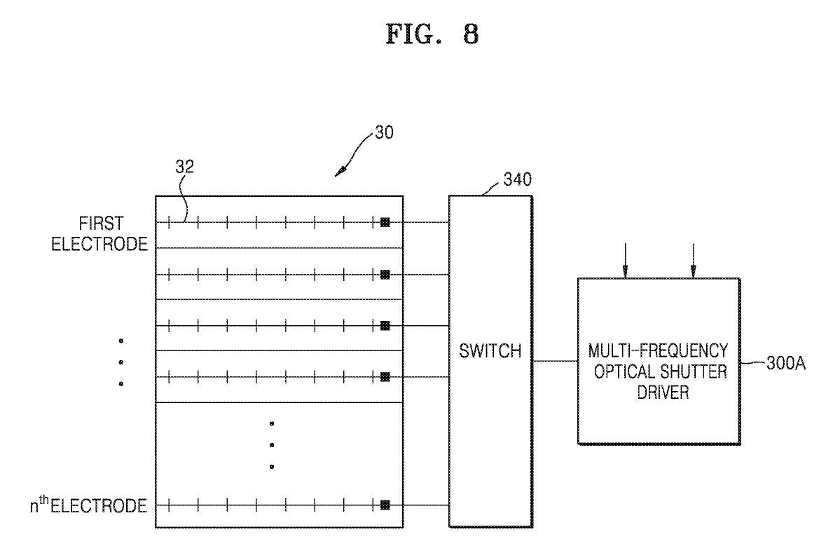

FIG. 7 is a flowchart illustrating a method of acquiring and processing an image of a 3D depth sensor according to an exemplary embodiment. As described above, to independently operate each section of the optical shutter 30 of the 3D depth sensor 100 according to an exemplary embodiment, the section may be operated by using a time division method. When modulation frequencies and intensities for sections of the optical shutter 30 are different, images may be acquired for each section on a different time.

Referring to FIGS. 1 and 7, the image sensor 40 acquires a first object image by modulating light reflected from a first object outside the 3D depth sensor 100 in the first section of the optical shutter 30 by operating the first section of the optical shutter 30 (S110), and a first section image processing may be performed in the controller 50 (S111). At the same time, the image sensor 40 acquires a second object image in the second section of the optical shutter 30 by operating the second section of the optical shutter 30 (S120). Also, the image sensor 40 acquires a third object image in the third section of the optical shutter 30 by operating the third section of the optical shutter 30 (S130) simultaneously with a second section image processing (S121) in the controller 50. Next, a third section image processing is performed in the controller 50 (S131). In this manner, an interference phenomenon that may occur due to different frequencies or different intensities during the time division operation of the optical shutter 30 may be prevented. The method of operating the 3D depth sensor 100 of FIG. 7, according to an exemplary embodiment is an example, and thus, an operation sequence of the sections of the optical shutter 30, an image acquisition sequence, and a cycle and time difference of each of steps may be arbitrary set.

As described above, because the optical shutter 30 of the 3D depth sensor 100 according to an exemplary embodiment is divided into sections and the sections are operated independently from one another, image sizes of sections may be different from each other according to time. An image capture and an image processing may be performed only with respect to a portion that satisfies a region of interest (ROI) in each region and time. Accordingly, an additional image processing is possible according to the ROI, and processing resources that include a 3D depth sensor may be optionally allocated. That is, a large amount of processing resources are allocated with respect to an ROI having a high degree of precision, and a small amount of processing resources may be allocated to an ROI having a low degree of precision.

FIG. 8 is a diagram of a structure of the optical shutter 30 including a switch that optionally connects each of the sections of the optical shutter 30 and a multi-frequency optical shutter driver of the 3D depth sensor 100, according to an exemplary embodiment.

Referring to FIGS. 1 and 8, the 3D depth sensor 100 according to an exemplary embodiment may include an analogue switch 340 connected to first through nth electrodes 32, and the analogue switch 340 may be connected to an optical shutter driver 300A. The optical shutter driver 300A may be a multi-frequency optical shutter driver, and may operate electrodes of the first through nth electrodes 32 in a desired region corresponding to each of the sections of the optical shutter 30 by being arbitrarily connected to the electrodes by the analogue switch 340.

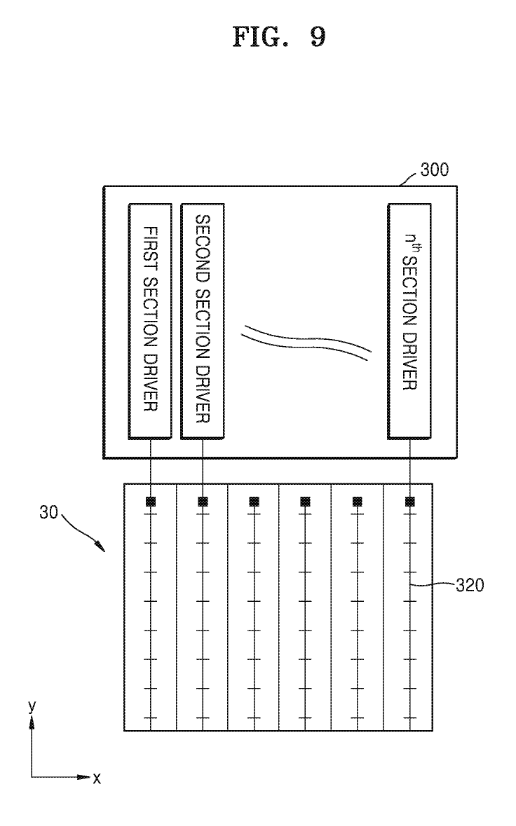

FIG. 9 is a diagram of a structure of an optical shutter driver in which optical shutter electrodes of the 3D depth sensor 100 according to an exemplary embodiment are formed in a vertical direction and each electrode line and a shutter driver are vertically connected to each other. Referring to FIG. 9, a plurality of electrodes 320 formed on the optical shutter 30 may be formed in a vertical direction, and the optical shutter driver 300 may be connected to the electrodes 320 corresponding to the shape of the electrodes 320. That is, the connection between the optical shutter driver 300 and the electrodes 320 may be applied to the purpose of using the 3D depth sensor 100 according to an exemplary embodiment.

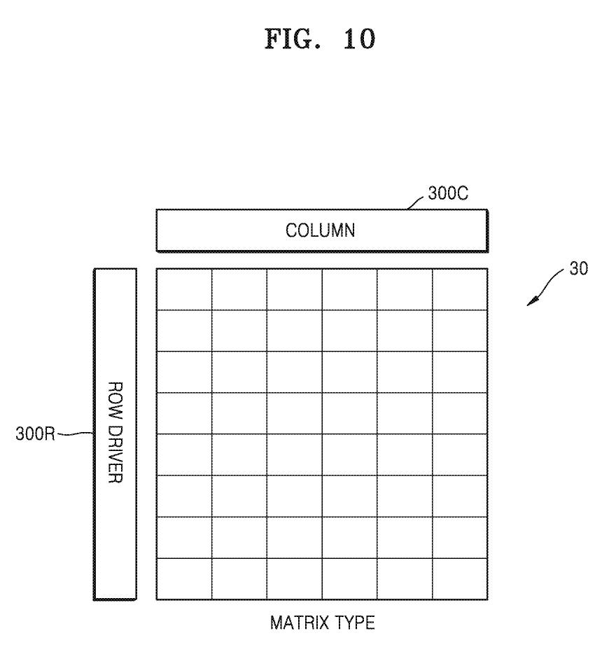

FIG. 10 is a diagram showing a matrix-type arrangement of driving electrodes of the optical shutter 30 of the 3D depth sensor 100, according to an exemplary embodiment. FIG. 10 shows an electrode structure in which the driving electrodes that apply a driving voltage to the optical shutter 30 are arranged in a matrix-type, and a column driver 300C and a row driver 300R are formed in matching with the shape of the driving electrodes. In this manner, the using environment may be extended by arranging the driving electrodes and the optical shutter drivers 300C and 300R in a matrix-type.

In a 3D depth sensor according to an exemplary embodiment, an optical shutter may be divided into at least two sections, and each of the sections may be operated independently from one another. Because the sections of the optical shutter are operated independently from one another, optimum distance information according to the location of an object from the 3D depth sensor may be provided. Also, distance information may be acquired by setting an appropriate intensity of light according to the location of the object from the 3D depth sensor, and thus, problems such as optical saturation at near distances and lack of intensity at far distances may be addressed.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A three-dimensional (3D) depth sensor comprising:
a light source configured to emit light toward an object;
an optical shutter configured to modulate a waveform of light that is reflected from the object by changing a transmittance of the reflected light, the optical shutter comprising sections;
an optical shutter driver configured to operate the sections of the optical shutter independently from one another; and
a controller configured to control the light source and the optical shutter driver.

2. The 3D depth sensor of claim 1, wherein the optical shutter driver comprises optical shutter drivers individually connected to electrodes respectively included in the sections of the optical shutter.

3. The 3D depth sensor of claim 2, further comprising a switch configured to select an electrode from the electrodes,
wherein the optical shutter driver is further configured to operate the electrodes via the switch.

4. The 3D depth sensor of claim 3, wherein the optical shutter driver comprises a multi-frequency optical shutter driver configured to select, from frequencies, a frequency for operating the optical shutter.

5. The 3D depth sensor of claim 1, wherein the sections of the optical shutter are configured to respectively modulate the reflected light reflected, based on locations of the object from the 3D depth sensor.

6. The 3D depth sensor of claim 1, wherein the optical shutter comprises a first electrode, a second electrode, and a multi-quantum well (MQW) structure disposed between the first electrode and the second electrode.

7. The 3D depth sensor of claim 6, further comprising a first conductive type semiconductor layer disposed between the first electrode and the MQW structure, and having an n-type distributed bragg rectifier (DBR) structure.

8. The 3D depth sensor of claim 7, further comprising a second conductive type semiconductor layer disposed between the second electrode and the MQW structure, and having a p-type DBR structure.

9. A method of measuring a distance to an object, using a 3D depth sensor comprising a light source emitting light towards an object, an optical shutter modulating a waveform of light that is reflected from the object by changing a transmittance of the reflected light, the optical shutter comprising sections, and an optical shutter driver operating the sections of the optical shutter independently from one another, the method comprising:
emitting light from the light source toward different locations of the object with respect to the 3D depth sensor; and
acquiring distance information of the object from the 3D depth sensor by operating the sections of the optical shutter independently from one another.

10. The method of claim 9, further comprising operating the sections of the optical shutter at different times, based on a time division method.

11. The method of claim 10, further comprising:
operating an electrode included in a first section of the optical shutter via a first section driver included in the optical shutter driver; and
after the operation of the electrode included in the first section of the optical shutter via the first section driver, operating an electrode included in a second section of the optical shutter via a second section driver included in the optical shutter driver.

12. The method of claim 9, wherein the optical shutter driver is a multi-frequency optical shutter driver operating electrodes included in the sections of the optical shutter via a switch that selects an electrode from the electrodes.
